(19) United States
(12) Patent Application Publication
(10) Pub. No.: US 2007/0047218 A1
(43) Pub. Date: Mar. 1, 2007

(54) Desk lamp with multi-function

(76) Inventor: Hsin-mao Hsieh, Pingtung City (TW)

Correspondence Address: TROXELL LAW OFFICE PLLC;SUITE 1404, 5205 LEESBURG PIKE, FALLS CHURCH, VA, 22041, US

(21) Appl. No.: 11/209,610

(22) Filed: Aug. 24, 2005

(51) Int. Cl. F21V 33/00; H05B 11/00

(52) U.S. Cl. 362/92; 362/411; 362/234; 362/253; 219/220

(57) ABSTRACT

A desk lamp with multi-function includes a lamp body, a negative ion generator, a thermostatic cup holder and an integrated power controller. The lamp body includes a lamp base, a lamp arm and a lamp shade. The negative ion generator is disposed inside the lamp body. The thermostatic cup holder is disposed inside the lamp base and has an exposed heat transmission pad. The integrated power controller is disposed inside the lamp base and has a plurality of power switch respectively and electrically connected to the lamp shade, the negative ion generator and the thermostatic cup holder to integrate the powers with a power plug.

### FIELD OF THE INVENTION

The present invention relates to a desk lamp with multi-function, more particularly to a desk lamp with multi-functions of generating negative ions and thermostatic control for drinks.

### BACKGROUND OF THE INVENTION

Readers also often prepare a cup of hot or ice drink while reading, however. Besides, due to too much positive ion included in the air around the reader, reader may be easy to suffer headache or tire and thereby influence reading efficient.

Reading is a direct way to increase knowledge for most people. A desk lamp is usually utilized for lighting while reading. Normally readers often prepare a cup of hot or cold drink while reading. However the drink will intend to restore to a room temperature naturally. A reading interruption perhaps happens when hot drink needs to be reheated or ice drink needs to replenish ice cutes. Furthermore readers may be easy to suffer headache or tired so as to lower the reading efficiency when much positive ions in the environment while reading.

### SUMMARY OF THE INVENTION

It is a primary object of the present invention to provide a desk lamp with multi-function to effectively integrate a negative ion generator and a thermostatic cup holder inside a lamp body. The negative ion generator is disposed inside a lamp arm of the lamp body, and the thermostatic cup holder is disposed inside a lamp base of the lamp body to occupy rest inner space of the lamp body. The desk lamp includes an integrated power controller disposed inside the lamp base to control lighting, the negative ion generator, and the thermostatic cup holder. The desk lamp has a lighting function as well as negative ion generating and thermostat functions, also it is convenient to use and keeps its original outline.

It is a secondary object of the present invention to provide a desk lamp with multi-function, which includes an integrated power controller disposed inside a lamp base of a lamp body. The integrated power controller includes a circuit board, a controller chip, a plurality of passive components, and a plurality of power switches electrically connected to a lamp shade, a negative ion generator, and a thermostatic cup holder so as to integrate powers with a power plug to decrease power lines.

It is a third object of the present invention to provide a desk lamp with multi-function, wherein an opening is formed in a lamp base of a lamp body to expose a heat transmission pad of the thermostatic cup holder.

In accordance with the present invention, a desk lamp with multi-function mainly includes a lamp body, a negative ion generator, a thermostatic cup holder, and an integrated power controller. The lamp body includes a lamp base, a lamp arm and a lamp shade. The negative ion generator is disposed inside the lamp arm and has a heat transmission pad for placing a cup and keeping it thermostatic. The integrated power controller is disposed inside the lamp base and includes a plurality of power switches electrically and respectively connected to the lamp shade, the negative ion generator and the thermostatic cup holder.

### DESCRIPTION OF THE DRAWINGS

FIG. 1 is a perspective view of a desk lamp with multi-function in accordance with the first embodiment of the present invention.

FIG. 2 is a perspective view of another desk lamp with multi-function in accordance with the second embodiment of the present invention.

FIG. 3 is a perspective view of the desk lamp when a cup is placed on a heat transmission pad in accordance with the second embodiment of the present invention.

### DETAILED DESCRIPTION OF THE PRESENT INVENTION

Referring to the drawings attached, the present invention is described by means of the embodiment(s) below.

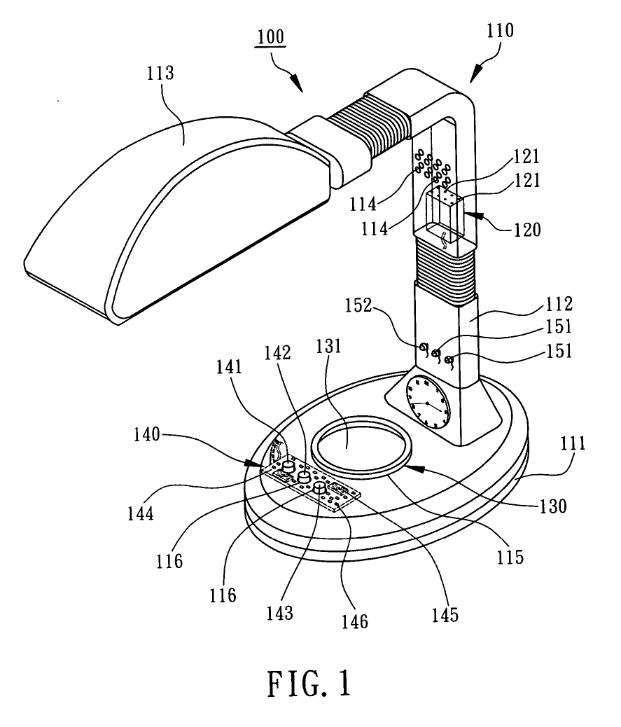

FIG. 1 shows a desk lamp 100 with multi-function in accordance with the first embodiment of the present invention. The desk lamp 100 mainly includes a lamp body 110, a negative ion generator 120, a thermostatic cup holder 130 with a heat transmission pad 131, and an integrated power controller 140. The lamp body 110 consists of a lamp base 111, a lamp arm 112 and a lamp shade 113. The lamp base 111 is utilized to place on a table or desk, and the lamp arm 112 connects the lamp base 111 with the lamp shade 113. In this embodiment, the lamp arm 112 is bendable to adjust relative location of the lamp shade 113 and the reader. A lamp tube or bulb is disposed inside the lamp shade 113 to provide a light source. (not shown in the figures)

The negative ion generator 120 is disposed inside the lamp arm 112 of the lamp body 110. In this embodiment, it has a plurality of whistlers 121, a driver circuit, a negative ion exciting electrode. (not shown in the figures) Besides, the lamp arm 112 has at least an output opening 114, the negative ions will be released from the whistlers 121 passing through the output opening 114 of the lamp arm 112 to blow to the reader in front of the desk lamp 100.

The thermostatic cup holder 130 is disposed inside the lamp base 111. The heat transmission pad 131 is exposed from a first opening 115 of the lamp base 111 for placing a cup on. Furthermore, the thermostatic cup holder 130 has a function of heating or cooling the heat transmission pad 131 as well as a function of detecting temperature of the heat transmission pad 131 to keep a drink in a cup thermostatic.

The integrated power controller 140 is disposed inside the lamp base 111 of the lamp body 110. In this embodiment, the integrated power controller 140 combines a plurality of power switches 141,142,143 on a circuit board 144 to turn on/off a lamp tube in the lamp shade 113, the negative ion generator 120, and the thermostatic cup holder 130. For example, a first power switch 141 is electrically connected to the lamp shade 113, a second power switch 142 is electrically connected to the negative ion generator 120, and a third power switch 143 is electrically connected to the thermostatic cup holder 130. The integrated power controller 140 further comprises at least a controller chip 145 and a plurality of passive components on the circuit board 144 so as to decrease power lines and power plugs. In this embodiment, the first power switch 141, the second power switch 142 and the third power switch 143 are knobs. The lamp base 111 further has a plurality of second openings 116 to expose the power switches 141,142,143.

In this embodiment, the lamp arm 112 of the lamp body 110 is installed with at least a thermostatic indicator 151 and a negative ion indicator 152, such as LED (Light Emitting Diode) lamp. The thermostatic indicator 151 and the negative ion indicator 152 are turned on to respectively show that the thermostatic cup holder 130 and the negative ion generator 120 working.

Accordingly, the desk lamp 100 can effectively applies the rest inner space of the lamp body 110 to integrate the negative ion generator 120 and the thermostatic cup holder 130. Since the integrated power controller 140 is disposed inside the lamp base 111 of the lamp body 110 to control light, generation of negative ion and thermostatic of cup, it is convenient to use and keeps its original outline.

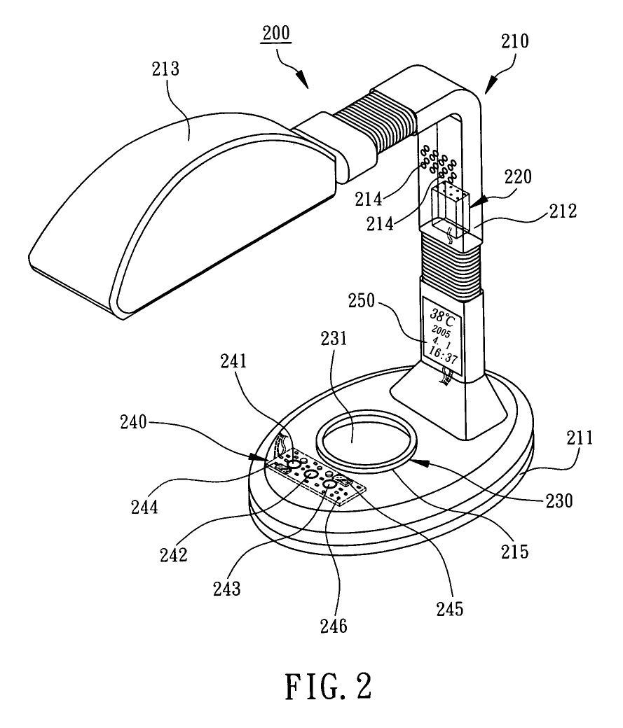

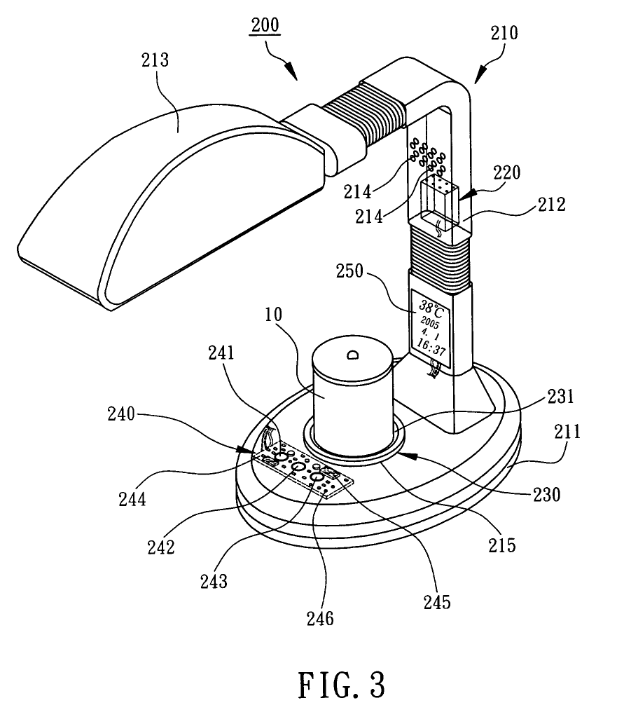

FIG. 2 shows a desk lamp 200 with multi-function in accordance with the second embodiment of the present invention. The desk lamp 200 includes a lamp body 210, a negative ion generator 220, a thermostatic cup holder 230 with a heat transmission pad 231, and an integrated power controller 240. The lamp body 210 includes a lamp base 211, a lamp arm 212 and a lamp shade 213, and may has a same shape as the first embodiment or other known shape. The negative ion generator 220 is disposed inside the lamp arm 212 to provide negative ions. The negative ions will be released from an output opening 214 of the lamp body 212 to blow to a place lighted by the desk lamp 200 so as to improve air circumstance around the desk lamp 200. The thermostatic cup holder 230 is disposed inside the lamp base 211, and the heat transmission pad 231 is exposed from an opening 215 of the lamp base 211 to place a cup 10 (as shown in FIG. 3) and keep it thermostatic. The integrated power controller 240 is disposed inside the lamp base 211 and it includes a first power switch 241, a second power switch 242 and a third power switch 243 for respectively controlling a lamp tube in the lamp shade 213, the negative ion generator 220 and the thermostatic cup holder 230. The integrated power controller 240 further includes a circuit board 244 for gathering the power switches 241,242,243, at least a controller chip 245, and a plurality of passive components 246 thereon. In this embodiment, the power switches 241,242,243 are buttons. Therefore, the desk lamp 200 not only can provide light for reading, but also provide negative ions for improving air circumstance around the desk lamp 200 and keep a cup thermostatic without reading interruption. Besides, the desk lamp 200 may further has a display panel 250 embedded in the lamp arm 250 to show working state of the negative ion generator 220 and the thermostatic cup holder 230 and temperature of the heat transmission pad 231, etc.

While the present invention has been particularly illustrated and described in detail with respect to the preferred embodiments thereof, it will be clearly understood by those skilled in the art various changed in form and details may be made without departing from the spirit and scope of the present invention.

What is claimed is:

1. A desk lamp comprising:
a lamp body including a lamp base, a lamp arm and a lamp shade, wherein the lamp arm connects the lamp base and the lamp shade;
a negative ion generator disposed inside the lamp arm to provide negative ions;
a thermostatic cup holder disposed inside the lamp base and having a heat transmission pad exposed; and
an integrated power controller disposed inside the lamp base and including a first power switch electrically connected to the lamp shade, a second power switch electrically connected to the negative ion generator, and a third power switch electrically connected to the thermostatic cup holder.

2. The desk lamp in accordance with claim 1, wherein the integrated power controller further comprises a circuit board for mounting the first power switch, the second power switch, and the third power switch thereon.

3. The desk lamp in accordance with claim 1, wherein the lamp base has a first opening to expose the heat transmission pad.

4. The desk lamp in accordance with claim 3, wherein the lamp base has a plurality of second openings to expose the first power switch, the second power switch and the third power switch.

5. The desk lamp in accordance with claim 1, further comprising a thermostatic indicator disposed on the lamp arm.

6. The desk lamp in accordance with claim 5, wherein the thermostatic indicator is a LED lamp.

7. The desk lamp in accordance with claim 1, further comprising a negative ion indicator disposed on the lamp arm.

8. The desk lamp in accordance with claim 1, further comprising a display panel embedded in the lamp arm.

9. The desk lamp in accordance with claim 1, wherein the lamp arm has at least an output opening for negative ions.

10. The desk lamp in accordance with claim 1, further comprising a lamp tube or a bulb disposed in the lamp shade.

11. The desk lamp in accordance with claim 1, wherein the lamp arm is bendable.
